(19) United States
(12) Patent Application Publication
(10) Pub. No.: US 2005/0089609 A1
(43) Pub. Date: Apr. 28, 2005

(54) Method and apparatus for converting germ

(75) Inventors: Andrea Angelini, Bologna (IT); Mario Menegatto, Taglio Di Po (IT); Francesco Pedrielli, Ferrara (IT)

Correspondence Address: WILLIAM J. SAPONE;COLEMAN SUDOL SAPONE P.C., 714 COLORADO AVENUE, BRIDGE PORT, CT, 06605, US

(73) Assignee: Ibetech S.R.L., Ariano nel Polesine (IT)

(21) Appl. No.: 10/508,395

(22) PCT Filed: Mar. 21, 2003
(86) PCT No.: PCT/IB03/01047

(30) Foreign Application Priority Data
Mar. 22, 2002 (IT) BO2002A000148

(51) Int. Cl. A23L 1/00

(52) U.S. Cl. 426/287; 426/481

(57) ABSTRACT

A method for converting germ (G) provides:
to subject germ (G) to a first hydrolysis (2) for converting starch associated to germ (G) in dextrins (D);
downstream the first hydrolysis (2), to subject germ (G) to a first separation (3), obtaining a fraction containing dextrin (D) and a first portion of oil (H) and proteins (L) associated to germ (G), separated from the latter purifying it;
to subject the purified germ (G) to grinding (4);
to subject the ground germ (G) to a second hydrolysis (5) for hydrolyzing the proteins (L) of germ (G);
downstream the second hydrolysis (5), to subject germ (G) to a second separation (6) obtaining a fraction containing bran (C), peptides and not hydrolyzed proteins which are separated from the remaining part of germ (G) consisting of a mixture containing amino acids (A) and a second portion of oils (H);
to subject the mixture containing oils (H) and amino acids (A) to a third separation (7) getting a solution of amino acids (A) separated from the remaining part of germ (G) substantially consisting in the second portion of oils (H); to store said second portion of oils (H).

### TECHNICAL FIELD

The present invention relates to vegetable product processing and it refers to a method and an apparatus for converting germ extracted from corn grains or other similar agricultural products.

### BACKGROUND ART

There are known methods and apparatuses or plants capable to extract oils and bran from germ through hot toasting and pressing of ground germ in order to separate a part of the oils from bran. The large amount of oil left in the bran is extracted through an organic solvent, mainly hexane, and stored with the pressing oil.

The main drawback of said known methods and apparatuses consists in that the hexane is highly inflammable and toxic, obliging to build complex and expensive apparatuses with antiexplosive characteristics and provided with special safety devices that however can not eliminate the risk of accidents or health damages for the apparatus staff and the customers.

Other drawback of known methods and apparatuses consists in that they cause the loss of a large amount of vitamins, pigments and active principles of the oil. Further drawback of known methods and apparatuses consists in that they provide bran enriched with not separable germ proteins which is not optimal for animal feeding. In fact, since the monogastric animals use the proteins and only a small quantity of bran cellulose, while the poligastric animals use the cellulose and they assume only a small amount of proteins, the enriched bran obtained by the known methods cause waste of foods and of animal chemical energy.

Other drawback consists in the protein denaturation and in the loss of amino acids and of simple sugars and therefore in the reduction of the digestibility of fodders obtained by the known methods and apparatuses.

Further drawback of known methods and apparatuses consists in that they require a lot of water and energy and they produce polluting mud.

Documents U.S. Pat. No. 1,892,449 discloses the use of enzymes such as diatase which hydrolyses starch and pepsin which hydrolyses protein to assist in liberating oils such as corn oil.

### DISCLOSURE OF THE INVENTION

Object of the present invention is to propose a method and an apparatus capable to provide oils without using organic solvents and thus safe for the production workers and for the feeding.

Other object of the present invention is to propose a method and an apparatus fit to provide digestible oils and without remarkable losses of vitamins, pigments and active principles.

Further object of the present invention is to propose a method and an apparatus capable to provide germ proteins, also separated and not denatured and thus highly digestible and safe.

Other object of the present invention is to propose a method and an apparatus capable to provide amino acids, sugars, alcohol, enriched bran and other products for human feeding and for fodders, without requiring to use organic solvents.

Other object of the present invention is to propose a method and an apparatus capable to reutilize the distillation water and its thermal energy in order to reduce the energetic costs and the pollution.

### BRIEF DESCRIPTION OF THE DRAWINGS

The characteristics of the present invention are underlined in the following with particular reference to attached drawings, in which:

FIG. 1 shows a flowchart of the method object of the present invention in which the phases are represented by rectangles and the initial, intermediate and final products are represented by circles;

FIG. 2 shows a schematic and partial view of the apparatus of the present invention.

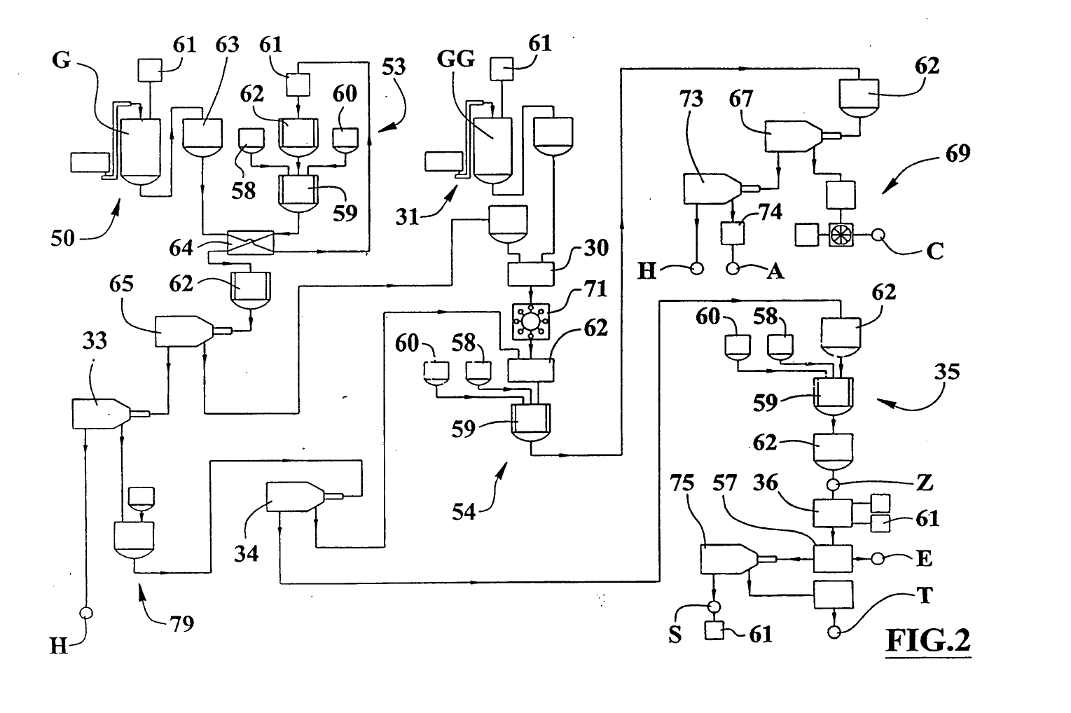

### BEST MODE OF CARRYING OUT THE INVENTION

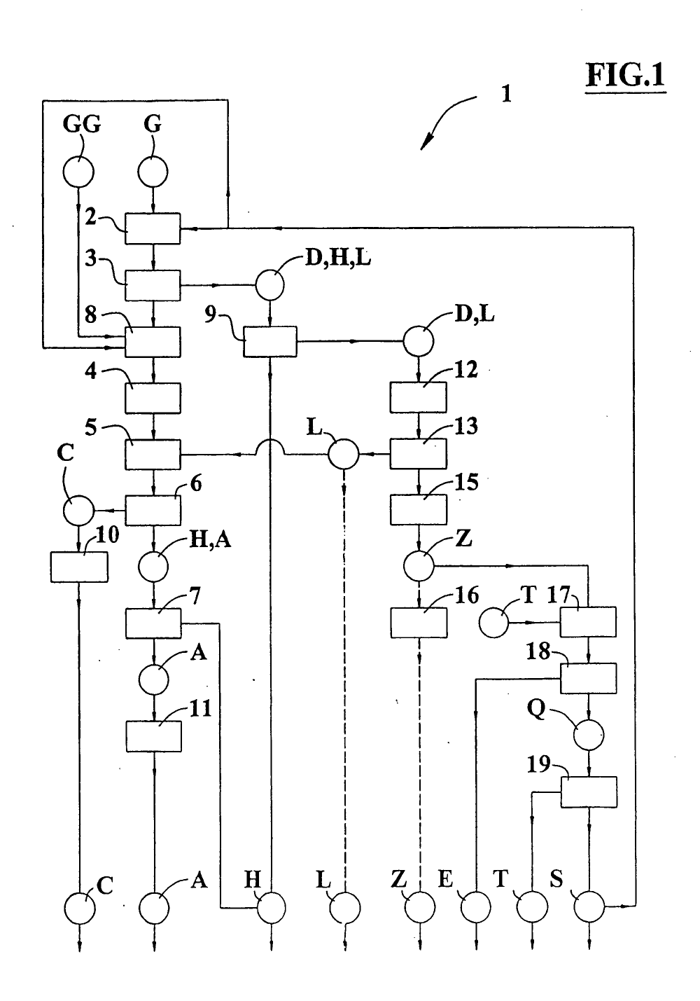

With reference to FIG. 1, numeral 1 indicates the method for converting germ object of the present invention.

The germ G is obtained via mechanical separation from corn grains or kernel, carried out in a mill; the germ G can be also extracted from soy, wheat or other cereals.

The surface of said germ G is associated to residual products of the seed, from which the germ has been mechanically separated; the residual products include starch and other materials such as proteins and oils. The method 1 provides also the use of the germ without starch GG, derived by starch extraction processes carried out in production plant thereof.

The method for converting the germ G, in sequence provides:
to subject the germ G mixed with a liquid, such as water, to a first hydrolysis 2 of amylolytic type executed at around 95° C. through alpha-amylase enzyme and a respective additive for converting starch associated to germ G in dextrins D;
downstream the first hydrolysis 2 to subject the germ G to a first separation 3, by centrifugation, obtaining a fraction containing dextrin D and a first portion of oils H and proteins L associated to germ G separated from the latter, which is so purified from starch and associated substances;
to subject germ without starch GG to mixing 8 with the purified germ G and with liquid, such as water;
to subject the purified germ G, GG, to grinding 4 of humid and fine type;
to subject the ground G, GG to a second hydrolysis 5, of proteolytic type, operated at temperatures ranging from around 50° C. to around 70° C. through a respective enzyme and a related additive, for hydrolyzing at least part of the remaining proteins L of germ G, GG;
to subject the germ G, GG to a second separation 6, through forced decantation, obtaining a fraction containing bran C, peptides and proteins not hydrolyzed separated from the remaining part of germ G, GG consisting a mixture containing amino acids A and a second huge portion of oils H;
to subject the mixture containing oils H and amino acids A to a third separation 7, through centrifugation, obtaining a solution of amino acids A separated by the remaining part of germ G and mainly consisting of second portion of oils H;
to store said second portion of oils H.

The fraction containing bran C, peptides and proteins not hydrolyzed is subjected to a first desiccation 10 to obtain dried bran C charged with peptides and proteins.

The method 1 provides to subject the fraction containing dextrins D and the first portion of oil H and proteins L of the germ G, separated from the latter by first separation 3, to a fourth separation 9, carried out by centrifugation, obtaining a solution including dextrins D and proteins L separated from the first oil portion H. This last portion is fit to be stored together with the second portion of oils H.

The solution including dextrins D and proteins L is subject, in sequence, to acidification 12, obtained through organic or mineral acids at a temperature ranging between 50° C. and 70° C., and to a fifth separation 13, carried out by centrifugation, to obtain separate solutions of dextrins D and of proteins L.

The method 1 provides to subject the solution of proteins L to the second hydrolysis 5 together with the ground germ G, GG or, alternatively, to a second desiccation 14 in order to obtain dry proteins L for storage.

The solution of dextrins D is subjected to a third hydrolysis 15, through respective enzyme and additive, to obtain from the dextrins D sugars Z, mainly consisting of glucose.

Sugars Z are subjected to a second concentration 16 to obtain concentrated sugars Z or, alternatively, they are subjected, in sequence, to fermentation 17, through yeasts T, and to distillation 18 obtaining, separate, a liquid Q and alcohols E; these last for storage.

The liquid Q is subjected to a sixth separation 19, by centrifugation, to separately obtain an aqueous liquid S, almost without solid residual products and in solution, and fermentation yeasts T for storage. The aqueous liquid S is used for adding liquid to the germ G in the first hydrolysis 2 and in the mixing 8 recycling water and the distillation thermal energy.

The method 1 also provides the use of aqueous liquid S for cooking corn grains to obtain a sanified food.

The amino acid solution A, obtained from the third separation 7, is subjected to a first concentration 11 obtaining concentrated amino acids A for storage.

The method provides that the separations third 7, fourth 9, fifth 13 and sixth 19 are obtained through vertical type centrifugation.

The apparatus for converting germ G of the present invention includes first container and moving means 50 including a hopper and a conveyor for filling a tank, provided with water delivering means 61, with germ G coming from a mill, or similar, and obtained from corn grains, soy, heat or other cereals. The germ G is associated with fragments of grain endosperm, or seeds, containing starch, oils, proteins and dextrins in remarkable quantity and depending on the source material and on the previous performed processes.

The first container and moving means 50 are in cascade connected to:
a station of first amylolytic hydrolyses 53;
germ separating means 65 having an exit for a fraction containing at least oils, proteins and dextrins associated to germ G and a separate exit for the germ G purified from the associated substances;
fine grinding means 71 of the purified germ G, whose inlet is connected to the respective outlet of the germ separating means 65;
a station of second proteolytic hydrolyses 54 for converting proteins of germ G in amino acids;
protein fraction separating means 67 having an outlet for a fraction including bran, peptides and not hydrolyzed proteins and a separate outlet for oils and amino acids;
amino acids separating means 73 whose inlet is connected to the outlet for oils and amino acids of protein fraction separating means 67 and having an amino acids outlet connected to concentration means 74 in order to provide concentrated amino acids A and a separate outlet for a oily fraction H.

The germ separating means 65, for separating the protein fraction 67 and the amino acids 73, consist of forced decanters, or horizontal or vertical centrifugal separators.

It is also provided that the protein fraction separating means 67 and the amino acids separating means 73 can be integrated in a single device of tricanter type, having three separate outlets for the fraction including bran, peptides and not hydrolyzed proteins, for the amino acids N and for the oily fraction H.

The apparatus includes mixing means 30 having an inlet and an outlet interconnected between the outlet for the purified germ G of the germ separating means 65 and the inlet of grinding means 71 and having a further inlet connected to second container and moving means 31 of germ G coming from starch separating apparatuses and thus almost without endospermatic material and consequently already purified from the products associated thereof.

The first hydrolyses station 53 includes heat exchanger means 64 inserted in the inlet and outlet connections of at least one of the hydrolysis stations 53, 54 for heat regeneration.

The outlet for the fraction including bran, peptides and not hydrolyzed proteins of the protein fraction separating means 67 is connected to desiccation means 69 to provide bran, not hydrolyzed proteins and dried peptides for animal use, for instance.

The outlet for the fraction containing oils, proteins and dextrins of the germ separating means 65 is connected to oil separating means 33 provided with an outlet for a oily fraction H and an outlet for a fraction containing proteins and dextrins.

This last outlet is connected in cascade to acidification means 79, for the insolubilization and precipitation of proteins, to dextrins separating means 34 having an outlet for dextrins and an outlet for proteins in flow communication with the second hydrolyses station 54.

The outlet of oily fractions H of the amino acids separating means 73 and oil separating means 33 flow into a oil tank, of known type and not shown.

The dextrins exit of the dextrins separating means 34 is connected in cascade to a third hydrolyses station 35 for converting the dextrins in sugars, to fermentation means 36 for converting sugars in alcohol, to a distillation station 57 provided with an outlet for an aqueous liquid S containing yeasts and with an outlet for alcohol E.

The fermentation means 36 are provided with fermentation yeast feeding means and they are connected to water delivering means 61.

The outlet of the aqueous liquid S of the distillation station 57 is connected to yeast separating means 75, of centrifugal type, an outlet of which provides yeast T and the remaining outlet provides aqueous liquid S depurated from yeasts and connected to the water delivering means 61 for feeding or helping to feed with water these last.

Each hydrolysis station first 53, second 54 and third 35 includes a thermoregulated enzymatic room 59 into which respective enzyme delivering means 58 and additive delivering means 60 flow for inserting in the rooms 59 respective enzymes and additive.

Each hydrolysis station 53, 54, 35 includes storage means 62, 63 positioned upstream and downstream the related enzymatic room 59, consisting of tanks fit for the continuity of the production flow.

The enzymatic room 59 of the first hydrolysis station 53 is in flow communication with water delivering means 61 for charging germ with water.

The apparatus also includes a plurality of pipes, valves, heaters, sensors, pump means and intermediate tanks, known and not shown, fit for the circulation and the adjustment of production.

The main advantage of the present invention is to provide a method and an apparatus capable to provide oils without using organic solvents and thus safe for the production workers and for the feeding.

Other advantage of the present invention is to provide a method and an apparatus for obtaining amino acids, sugars, alcohol, oils, bran and proteins also separated and other products not denatured and thus highly digestible and safe for human feeding and for fodders.

Other advantage is to provide a method and an apparatus capable to reutilize the aqueous liquid and its thermal energy in order to reduce the water and energy consumption.

Other advantage is to provide an apparatus fit for carrying out a continuous production with continuous feeding.

1) Method for converting germ (G) characterized in that provides:
to subject germ (G) to a first hydrolysis (2) for converting starch associated to germ (G) in dextrins (D);
downstream the first hydrolysis (2), to subject germ (G) to a first separation (3), obtaining a fraction containing dextrin (D) and a first portion of oil (H) and proteins (L) associated to germ (G), separated from the latter purifying it;
to subject the purified germ (G) to grinding (4);
to subject the ground germ (G) to a second hydrolysis (5) for hydrolyzing the proteins (L) of germ (G);
downstream the second hydrolysis (5), to subject germ (G) to a second separation (6) obtaining a fraction containing bran (C), peptides and not hydrolyzed proteins which are separated from the remaining part of germ (G) consisting of a mixture containing amino acids (A) and a second portion of oils (H);
to subject the mixture containing oils (H) and amino acids (A) to a third separation (7) obtaining a solution of amino acids (A) separated from the remaining part of germ (G) substantially consisting in the second portion of oils (H);
to store said second portion of oils (H).

2) Method according to claim 1 characterized in that provides to subject starchless germ (GG) with germ (G) purified from starch to mixing (8), downstream the first separation (3) and upstream the second hydrolysis (5).

3) Method according to claim 1 characterized in that provides:
to subject the fraction containing dextrins (D) and the first portion of oil (H) and of proteins (L), associated to the germ (G) and separated from the latter through the first separation (3), to a fourth separation (9) obtaining a solution including dextrins (D) and proteins (L) separated from the first portion of oil (H);
to collect the first portion of oils (H) together with the second portion of oils (H).

4) Method according to claim 3 characterized in that provides to subject the solution including dextrins (D) and proteins (L), in sequence, to acidification (12) and to a fifth separation (13) for obtaining separated solutions of dextrins (D) and proteins (L).

5) Method according to claim 4 characterized in that provides to subject the solution of proteins (L) to second hydrolysis (5).

6) Method according to claim 4 characterized in that provides to subject the solution of proteins (L) to a second desiccation (14) to obtaining dried proteins (L).

7) Method according to claim 4 characterized in that provides to subject the solution of dextrins (D) to a third hydrolysis (15) to obtain sugars (Z) from the dextrins (D).

8) Method according to claim 7 characterized in that provides to subject sugars (Z) to a second concentration (16) to obtain concentrated sugars (Z).

9) Method according to claim 7 characterized in that to subject sugars (Z), in sequence, to fermentation (17) and to distillation (18) obtaining, separated, a liquid (Q) and alcohols (E) and to store these last ones.

10) Method according to claim 9 characterized in that provides to realize the fermentation (17) through yeasts (T).

11) Method according to claim 9 characterized in that to subject the liquid (Q) to a sixth separation (19) to obtain, separated, an aqueous liquid (S), almost without solid residues and in solution, and the fermentation yeasts (T) for storage.

12) Method according to claims 2 and 11 characterized in that provides to use, at least partially, the aqueous liquid (S) to add liquid to the germ (G) during at least one between the first hydrolysis (2) and the mixing (8).

13) Method according to claim 11 characterized in that provides to use, at least partially, the aqueous liquid (S) for cooking corn grains to obtain a sanified food.

14) Method according to claim 1 characterized in that provides to subject the fraction containing bran (C), peptides and not hydrolyzed proteins to a first desiccation (10) to obtain dried bran (C) charged with peptides and proteins.

15) Method according to claim 1 characterized in that provides to subject the solution of amino acids (A), obtained by third separation (7), to a first concentration (11), obtaining concentrated amino acids (A) and to store these last.

16) Method according to claim 1 characterized in that provides to carry out the first hydrolysis (2) of amylolytic type through alpha-amylase type enzyme and a respective additive.

17) Method according to claim 1 characterized in that provides to realize the second hydrolyses (5) of type proteolytic through a respective enzyme and a related additive.

18) Method according to claim 7 characterized in that provides to effect the third hydrolysis (15) through at least a respective enzyme and a respective additive.

19) Method according to claim 4 characterized in that provides to obtain the acidification (12) at least through organic or mineral acids at a temperature ranging between 50° C. and 70° C.

20) Method according to claim 1 characterized in that provide to obtain at least one of the separations first (3), second (6), third (7), fourth (9), fifth (13) and sixth (19) through forced decantation, vertical or horizontal centrifugation.

21) Apparatus for converting germ characterized in that includes, in cascade connection, at least:
first container and moving means (50) of the germ (G);
a station of first amylolytic hydrolyses (53);
germ separating means (65) having an exit for a fraction containing at least oils, proteins and dextrins associated to germ (G) and a separate exit for the germ (G) purified from the associated substances;
fine grinding means (71) of the purified germ (G), whose inlet is connected to the respective outlet of the germ separating means (65);
a station of second proteolytic hydrolyses (54) for converting proteins of germ (G) in amino acids;
protein fraction separating means (67) having an outlet for a fraction including bran, peptides and not hydrolyzed proteins and a separate outlet for oils and amino acids;
amino acids separating means (73) whose inlet is connected to the outlet for oils and amino acids of protein fraction separating means (67) and having an amino acids outlet connected to concentration means (74) in order to provide concentrated amino acids (A) and a separate outlet for a oily fraction (H).

22) Apparatus according to claim 21 characterized in that includes mixing means (30) having an inlet and an outlet interconnected between the outlet for the purified germ (G) of the germ separating means (65) and the inlet of grinding means (71) and having a further inlet connected to second container and moving means (31) of purified germ (G).

23) Apparatus according to claim 21 characterized in that each hydrolysis station first (53) and second (54) includes a thermoregulated enzymatic room (59) into which respective enzyme delivering means (58) flow.

24) Apparatus according to claim 23 characterized in that each enzymatic room (59) of the hydrolysis stations, first (53) and second (54), has additive delivering means (60).

25) Apparatus according to claim 23 characterized in that at least one of the hydrolysis stations first (53) and second (54) includes water delivering means (61) in flow communication with the respective enzymatic room (59).

26) Apparatus according to claim 21 characterized in that each hydrolysis station, first (53) and second (54), includes storage means (62), positioned upstream and downstream the related enzymatic room (59).

27) Apparatus according to claim 21 characterized in that at least one of the hydrolysis stations (53, 54) includes heat exchanger means (64) inserted in the inlet and outlet connections of at least one of the hydrolysis stations (53, 54).

28) Apparatus according to claim 21 characterized in that the protein fraction separating means (67) and the amino acids separating means (73) are integrated in a tricanter device.

29) Apparatus according to claim 21 characterized in that that the outlet for the fraction including bran, peptides and not hydrolyzed proteins of the protein fraction separating means (67) is connected to desiccation means (69) to provide bran, not hydrolyzed proteins and dried peptides (C).

30) Apparatus according to claim 21 characterized in that the outlet for the fraction containing oils, proteins and dextrins of the germ separating means (65) is connected to oil separating means (33) provided with an outlet for an oily fraction (H) and an outlet for a fraction containing proteins and dextrins in cascade connection to acidification means (79) for the insolubilization of proteins and dextrins, to dextrins separating means (34) having an outlet for the dextrins and an outlet for the proteins, in flow communication with the second hydrolyses station (54).

31) Apparatus according to claim 30 characterized in that the dextrins outlet of the dextrins separating means (34) is connected in cascade to a third hydrolyses station (35) for converting dextrins in sugars, to fermentation means (36) for converting sugars in alcohol, to a distillation station (57) provided with an outlet for an aqueous liquid (S), containing yeasts and an outlet for alcohol (E).

32) Apparatus according to claim 31 characterized in that the outlet of the aqueous liquid (S) of the distillation station (57) is connected to yeast separating means (75) an outlet of which provides yeasts (T) and the remaining one provides the aqueous liquid (S) purified from the yeasts, and is connected to the water delivering means (61) to feed these last ones.

33) Apparatus according to claims 25 and 32 characterized in that the outlet of the aqueous liquid (S) purified from the yeasts of the yeast separating means (75) feeds at least the water delivering means (61).

34) Apparatus according to claim 31 characterized in that the third hydrolyses station (35) includes a respective thermoregulated enzymatic room (59), into which respective delivering means of enzyme (58) and additive (60) flow, and it includes respective storage means (62) positioned upstream and downstream said enzymatic room (59).
